(19) United States
(12) Patent Application Publication
(10) Pub. No.: US 2008/0026180 A1
(43) Pub. Date: Jan. 31, 2008

(54) Impregnated inorganic paper and method for manufacturing the impregnated inorganic paper

(76) Inventors: Robert L. Bush, Elmira Heights, NY (US); Steven Bruce Dawes, Corning, NY (US); Francis Paul Fehlner, Corning, NY (US); Kishor Purushottam Gadkaree, Big Flats, NY (US); Sean Matthew Garner, Elmira, NY (US); Mark Alejandro Quesada, Horseheads, NY (US)

Correspondence Address: CORNING INCORPORATED, SP-TI-3-1, CORNING, NY, 14831, US

(21) Appl. No.: 11/493,741

(22) Filed: Jul. 26, 2006

(51) Int. Cl. C14C 9/00

(52) U.S. Cl. 428/141; 428/220; 428/540

(57) ABSTRACT

A flexible substrate is described herein which is made from a freestanding inorganic material (e.g., mica paper, carbon paper, glass fiber paper) with pores/interstices that have been impregnated with a special impregnating material (e.g., silsesquioxane, alkali silicate glass with weight ratio of SiO₂/X₂O (X is alkali Na, K etc.) between 1.6-3.5). In one embodiment, the flexible substrate is made by: (1) providing a freestanding inorganic material; (2) providing an impregnating material; (3) impregnating the pores/interstices within the freestanding inorganic material with the impregnating material; and (4) curing the freestanding inorganic material with the impregnated pores/interstices to form the flexible substrate. The flexible substrate is typically used to make a flexible display or a flexible electronic.

### BACKGROUND OF THE INVENTION

1. Field of the Invention

The present invention relates to an impregnated inorganic material and method for manufacturing the impregnated inorganic material. In one embodiment, the impregnated inorganic material (flexible substrate, impregnated inorganic paper) is used to make a flexible display or a flexible electronic.

2. Description of Related Art

The abbreviations below are herewith defined, at least some of which happen to be referred to in the following description.
Al Aluminum
CTE Coefficient of Thermal Expansion
IPA Isopropyl Alcohol
ITO Indium Tin Oxide
LCD Liquid Crystal Display
OLED Organic Light-Emitting Diode
PC Polycarbonate
PEN Polyethylene Naphthalate
PES Polyethersulfone
RH Relative Humidity
RFID Radio Frequency Identification
SEM Scanning Electron Microscopy
UV UltraViolet

Today, in applications associated with flexible displays (e.g., electrophoretic displays, cholesteric liquid crystal displays, OLED displays, LCD displays) and flexible electronics (e.g., photovoltaics, solar cells, RFIDs, sensors) there is a need for low cost flexible substrates which have improved durability, weight and bend radius. For instance, flexible substrates are being sought that have dimensional stability, desired CTE, toughness, transparency, thermal capability, and barrier properties/hermeticity which are suitable for active matrix display fabrication. Currently un-filled thermoplastic (PEN, PES, PC, . . . ) substrates, metal (stainless steel) substrates and thin glass substrates are being used for these applications. However, the plastic substrates by themselves suffer from poor O₂ and water vapor barrier properties, relatively high CTE, dimensional stability, thermal limits, and chemical durability. On the other hand, the metal substrates suffer from surface roughness, non-transparency, and conductivity while, the thin glass substrates are brittle and flaw sensitive, so bending and cutting are problematic. One main purpose of this invention is to provide a flexible substrate which has improved physical properties when compared to the properties of plastic substrates, metal substrates and continuous thin glass substrates. This need and other needs are satisfied by the flexible substrate and method of the present invention.

### BRIEF DESCRIPTION OF THE INVENTION

A flexible substrate is described herein which is made from a freestanding inorganic material (e.g., mica paper) with pores/interstices that have been impregnated with a special impregnating material (e.g., silsesquioxane, alkali silicate glass with weight ratio of SiO₂/X₂O (where X is alkali Na, K etc.) between 1.6-3.5 or combinations). In one embodiment, the flexible substrate is made by: (1) providing a freestanding inorganic material; (2) providing an impregnating material; (3) impregnating the pores/interstices within the freestanding inorganic material with the impregnating material; and (4) curing the freestanding inorganic material with the impregnated pores/interstices to form the flexible substrate. The flexible substrate is typically used to make a flexible display or a flexible electronic.

### BRIEF DESCRIPTION OF THE DRAWINGS

A more complete understanding of the present invention may be obtained by reference to the following detailed description when taken in conjunction with the accompanying drawings wherein:

FIG. 1 is a cross-sectional side-view of a flexible substrate (impregnated inorganic material) which is used to make a flexible display or flexible electronic in accordance with the present invention;

FIGS. 2A-2T show multiple photos and graphs that illustrate the results of various experiments which where conducted to evaluate several exemplary flexible substrates that had been made in accordance with the present invention;

FIG. 3 is a cross-sectional side-view of a flexible substrate (impregnated inorganic material) which is used as a protective coating on a glass substrate in accordance with the present invention; and

FIG. 4 is a graph that illustrates the results of an experiment which was conducted to evaluate how well an exemplary flexible substrate functions as a protective coating on a glass substrate in accordance with the present invention.

### DETAILED DESCRIPTION OF THE DRAWINGS

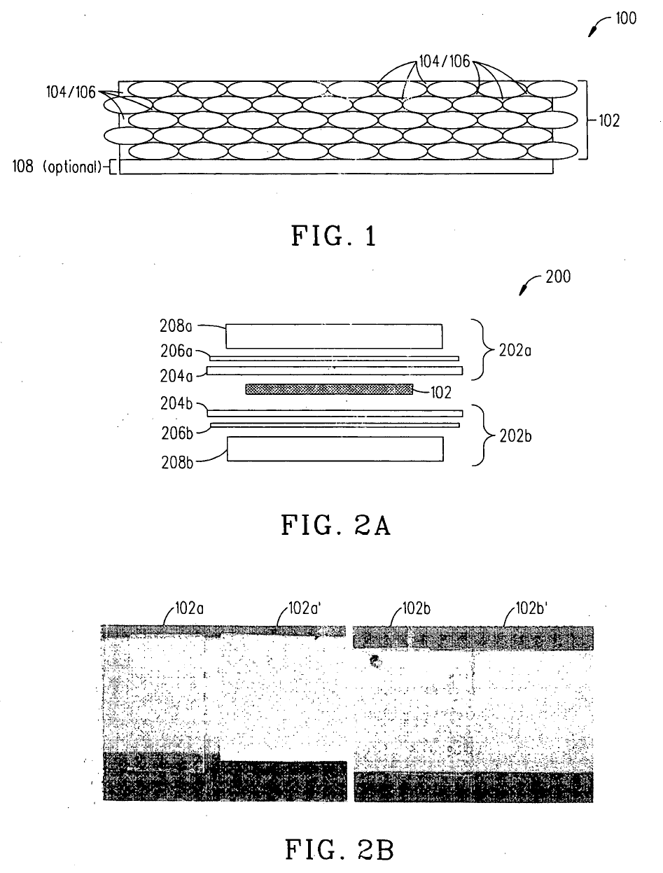

FIG. 1 is a cross-sectional side-view of a flexible substrate 100 (impregnated inorganic material 100) in accordance with an embodiment of the present invention. The flexible substrate 100 includes a freestanding inorganic material 102 (freestanding inorganic paper 102) with interstices/pores 104 impregnated with a special impregnating material 106. If desired, the flexible substrate 100 could have a barrier coating 108 placed on one or both surfaces to help improve a barrier property. For instance, the barrier coating 108 could be a deposited inorganic layer (e.g., silica, silicon nitride, . . . ), a multi-layer inorganic/organic layer stack (e.g., Barix™ coating from Vitex Systems, . . . ), or a continuous thin organic sheet (e.g., Corning's Microsheet, . . . ).

The freestanding inorganic material 102 is an assembly of particles (or fibers) which is composed of an inorganic material either crystalline or amorphous. For instance, the freestanding inorganic material 102 could be mica paper 102, graphite paper 102, carbon nanotube paper 102 or glass fiber paper 102. Generally, the type of freestanding inorganic material 102 which is selected to be used for a particular application is based on certain physical properties including, for example, material composition, mechanical properties, pore volume, particle size, aspect ratio and optical absorption. In addition, the freestanding inorganic material 102 is selected based on the type of device it is going to help make like a flexible display (e.g., electrophoretic display, cholesteric liquid crystal display, OLED display, LCD display, other active or passive matrix displays and drive circuitry) or a flexible electronic (e.g., photovoltaic, solar cell, RFID, sensors).

The impregnating material 106 is selected based in part on how well it can impregnate the pores/interstices 104 within the freestanding inorganic material 102. For instance, the two types of impregnating material 106 which are disclosed herein that have been used to impregnate the pores/interstices 104 within the freestanding inorganic material 102 include a sol-gel silsesquioxane material 106 and a potassium silicate glass 106 (where the potassium silicate glass has a weight ratio of SiO₂/K₂O of 2.5). But, other types of impregnating material 106 could be used instead so long as that material can effectively impregnate the pores/interstices 104 within the freestanding inorganic material 102. In addition, the impregnating material 106 is selected based in part on whether or not it can make a flexible substrate 100 which has desirable physical properties so one can use it to make a flexible display and/or a flexible electronic. TABLE 1 contains a list of the desirable physical properties which have been exhibited by an exemplary flexible substrate 100 so it could be used to make a flexible display or flexible electronic.

TABLE 1

| Physical Properties/Parameters | Minimum | Maximum |
|---|---|---|
| *Thermal capability (<0.5% wt loss after | 300 | |
| 1 hr) (° C.) | | |
| **Composite fabrication temperature (° C.) | | 1000 |
| Substrate CTE (ppm/° C.) | | 20 |
| Substrate thickness (um) | | 500 |
| Tensile strength of composite (MPa) | 200 | |
| O₂ transmission rate (cc/m²/day) | | 1 |
| (measured at 40 C and 90% relative humidity) | | |
| water vapor transmission rate (g/m²/day) | | 1 |
| (measure at 40 C and 90% relative humidity) | | |
| Composite density (g/cm³) | 1.3 | |
| Bend radius (cm) | | 5 |
| (minimum radius achievable before breakage or | | |
| other permanent distortion***) | | |
| Substrate surface roughness (Ra) (um) | | 0.5 |

*A minimum substrate use temperature which is greater than 300° C. is a property that can not been obtained by traditional commercially available inorganic papers which are impregnated with a polymer or a silicone (for example US Samica 4791-4 silicone bonded mica paper).
**A substrate fabrication temperature of less than 1000° C. is a property that can not been obtained by traditional inorganic composites through processes such as glass melt processes or typical pyrolization processes.
***The filled substrate when bent is not permanently bent but instead is temporarily flexed from a flat state.

In one embodiment, the flexible substrate 100 is made from freestanding mica paper 102 and sol-gel silsesquioxane impregnating material 106. The silsesquioxane impregnating material 106 was selected to be used for a variety of reasons including (for example):

1. The silsesquioxane impregnating material 106 can effectively infiltrate the pores/interstitials 104 of a pre-formed mica paper 102 so one can make a low porosity/highly inorganic composite flexible substrate 100.

2. The silsesquioxane impregnating material 106 can be used to make a flexible substrate 100 which has a denser matrix than if one used a lower temperature silicone or a polymer impregnating material.

3. The silsesquioxane impregnating material 106 makes a flexible substrate 100 which has a higher thermal capability than if one used an organic impregnating material.

4. The silsesquioxane impregnating material 106 is processable in that one can make a hydrolyzed resin of silsesquioxane which can be thermally cured using a mild thermal treatment with minimal shrinkage and minimal mass loss enabling processing that minimizes shrinkage cracks or open porosity.

5. The silsesquioxane impregnating material 106 has an index of refraction which can be varied over a range 1.40<n<1.60 in the visible spectrum so one can optimize an optical match with the freestanding inorganic material 102 such as a glass fiber paper.

6. The silsesquioxane impregnating material 106 is easy to process and has a lower modulus, higher strain tolerance when compared to fully inorganic impregnating materials like glass.

7. The silsesquioxane impregnating material 106 has a better thermal durability, and less damp heat vulnerability, when compared to most organic polymer impregnating materials.

8. The combination of silsesquioxane impregnating material 106 with a mica paper 102 has a desirable form and desirable physical properties like flexibility, thermal durability, permeation resistance, and a low CTE (see TABLE 1).

9. The silesquioxane impregnating material 106 requires a lower processing temperature than other material such as glass (from a melt process), pyrolized carbon or ceramic impregnating materials.

A detailed discussion about the composition of silsesquioxane 106 which was originally used to make planar waveguide structures is provided in the following co-assigned patents:
U.S. Pat. No. 5,991,493 entitled “Optically Transmissive Bonding Material”.
U.S. Pat. No. 6,144,795 entitled “Hybrid Organic-Inorganic Planar Optical Waveguide Device”.
U.S. Pat. No. 6,488,414 B1 entitled “Optical Fiber Component with Shaped Optical Element and Method of Making Same”.
U.S. Pat. No. 6,511,615 B1 entitled “Hybrid Organic-Inorganic Planar Optical Waveguide Device”.

The contents of these patents are incorporated by reference herein.

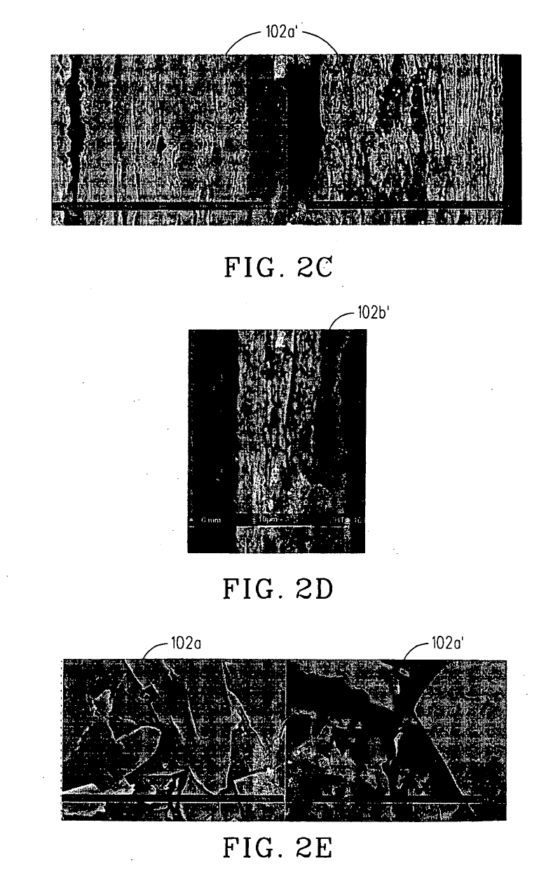

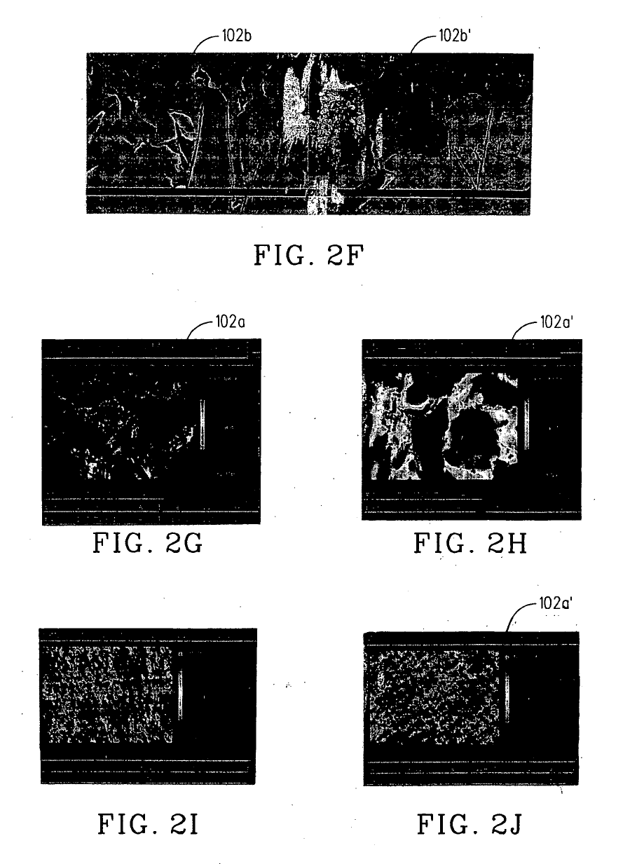

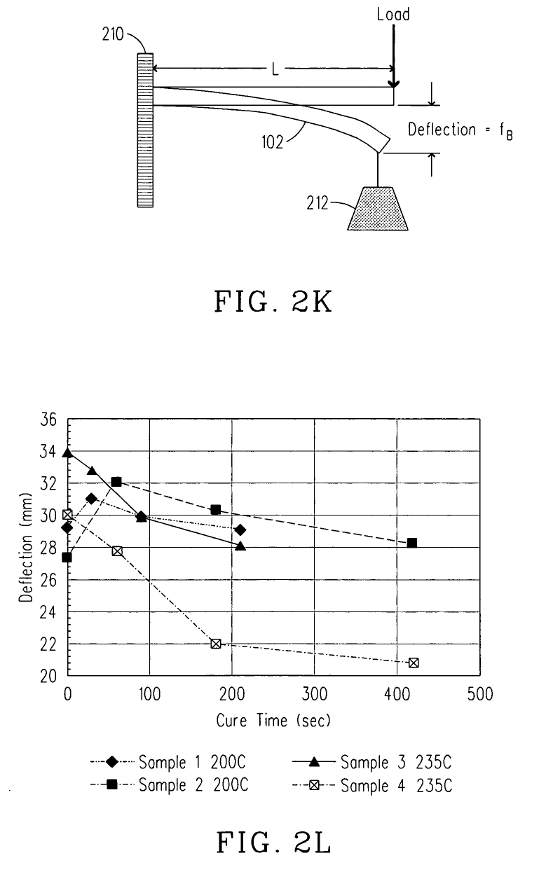

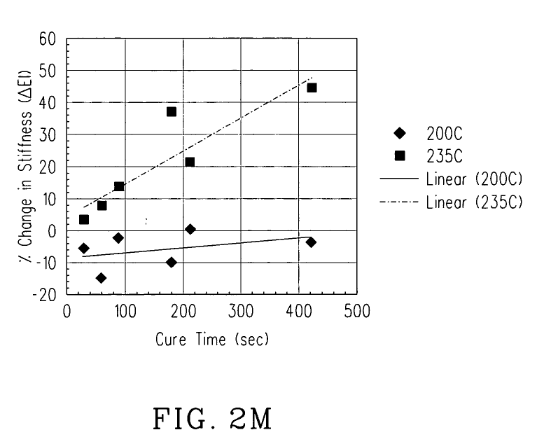

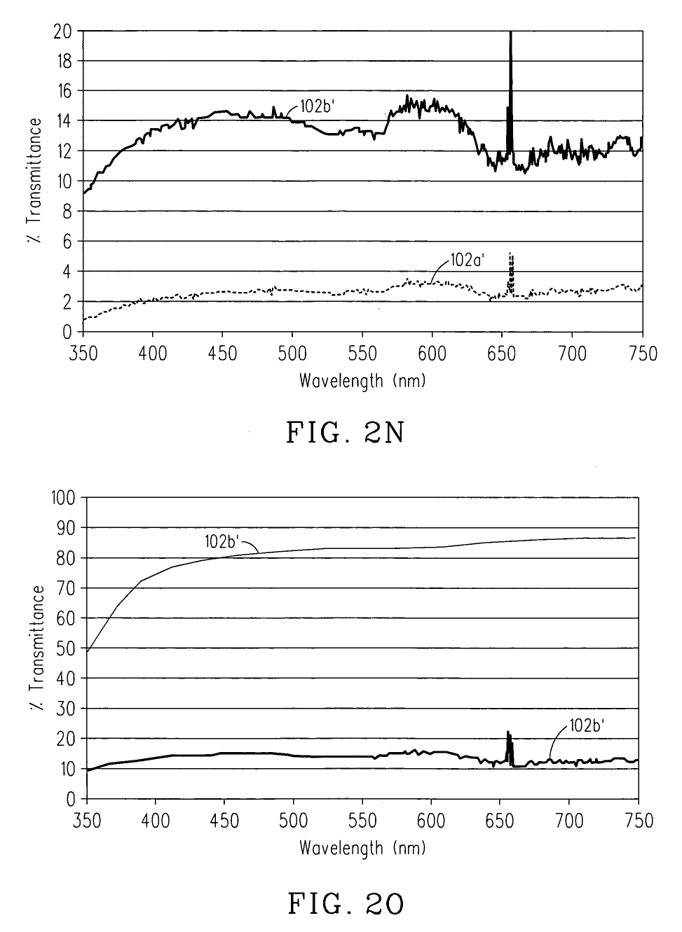

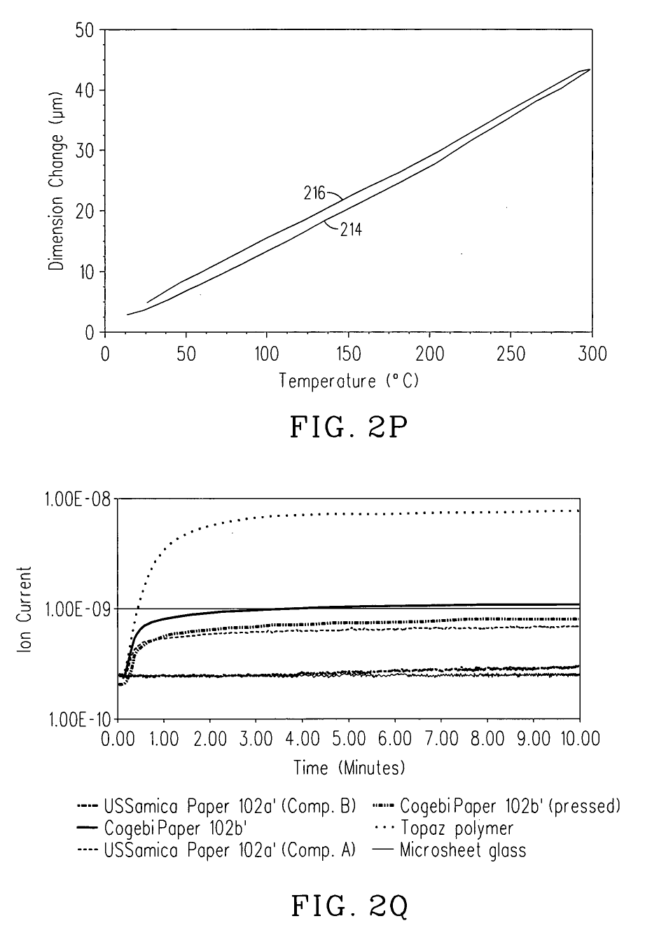

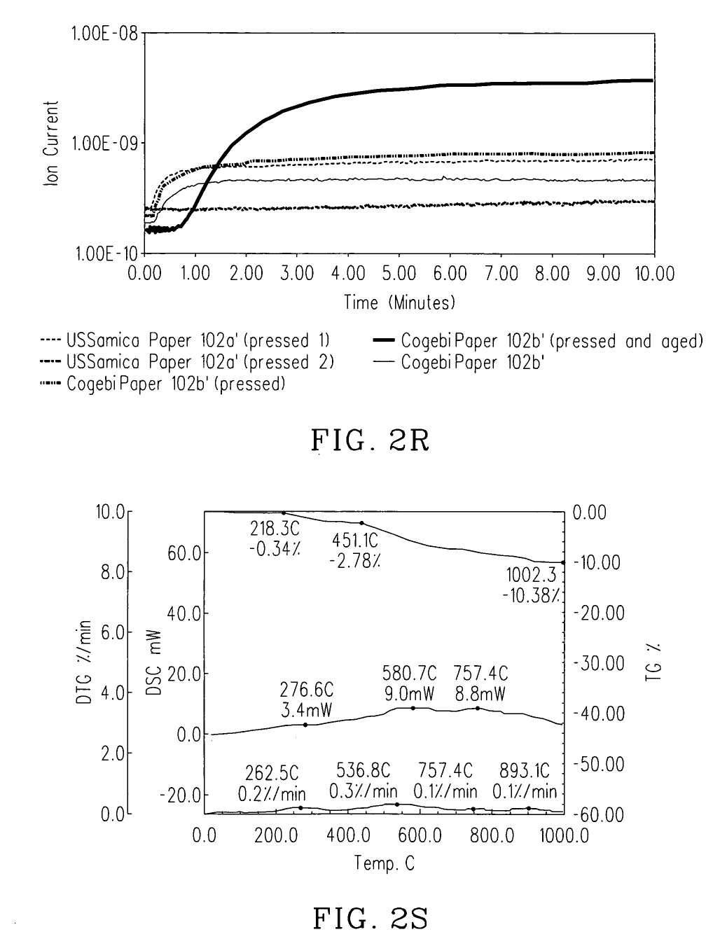

The inventors have tested the combined mica paper 102/silsesquioxane impregnating material 106 and evaluated the resulting flexible substrate 100 to determine if it can be used as a flexible display. A discussion about these tests and their results is provided next with respect to FIGS. 2A-2O.

### 1. EXPERIMENTAL

### 1A. Mica Paper Characteristics

Two commercially available mica papers 102 (and the silsesquioxane impregnating material 106) where used to make a impregnated mica display material 100. Both of the mica papers 102 are made from natural mica sources by USSamica Inc. and Cogebi Inc. and both have been typically used in the past as a dielectric layer in the electronic industry (e.g., capacitor applications). For instance, Cogebi's Cogecap mica paper is formed from a calcined muscovite natural mica. The baseline characteristics of these two mica papers 102 are provided in TABLE 2.

TABLE 2

| | USSamica | Cogebi Inc. |
|---|---|---|
| Characteristic | Inc. paper 102 | paper 102 |
| Thickness | ~80μ | ~15μ |
| Transparency | Very | Semi-transparent- |
| | opaque-silver | grey |
| Robustness | Relatively | Rather delicate |
| | strong | |
| Ease of | Easy | Rather difficult |
| handling | | to cut, tears |
| | | easily |
| Porosity | 35% | 35% |

The two mica papers 102 differ in mica particulate size and thickness, and consequently in fragility. But, both of the mica papers 102 rapidly disintegrate into constituent mica flakes when they are exposed to water.

### 1B. Sol-Gel Approach and Materials

A silsesquioxane material 106 was used to impregnate the interstices 104 of the two commercially available mica papers 102. The silsesquioxane material 106 is characterized by the general formula, RSiO_{3/2}, where R is an organic modifier that can range from simple methyl, ethyl and phenyl groups to more complex and reactive organic groups such as methacrylates, expoxides, and bridged compounds. The choice of reactive organic groups allows one to vary the index of refraction, and optimize the thermal and chemical durability of the impregnated inorganic paper 100. The silsesquioxane material 106 fits chemically between silica (SiO₂) and silicones (R₂SiO), and has intermediate properties. Because, the siloxane network forms a modified tetrahedra with three network Si—O—Si bonds, the density of the silsesquioxane material 106 is relatively high, which leads to better permeation properties than silicone impregnating materials. Typically, the measured densities of the silsesquioxane material 106 ranged from 1.3 to 1.4 g/cm³ depending on composition. Plus, the silsesquioxane material 106 can be cured with minimal shrinkage/mass loss which means it is suitable for impregnating the small scale pores 104 within the mica papers 102.

From the outset, the thermal durability and the refracting index match between the mica papers 102/silesequixane 106 were valued parameters for the resulting flexible substrate 100, where the former parameter offers a fundamental differentiation from polymer impregnating materials while the latter parameter enables transparency in the resulting flexible substrate 100. A combination of methyl and phenyl silsesquioxane precursors was chosen, so the thermal durability could exceed 350° C. for both materials, and the refractive index of the silsesquioxane 106 could be varied from 1.4 to 1.6 by increasing the proportion of the phenyl which is substituted into the composition.

In one experiment, polydimethylsiloxane, (average MW˜450AMU), methyltriethoxysilane, phenyltriethoxysilane and phenyltrifluorosilane/HF where used as precursors. And, the processing procedure involved a reaction of metallo-organic alkoxides with water, to form a fully hydrolyzed, partially condensed viscous resin after drying. Then, the resin was re-dissolved in isopropanol and the resulting solution of silsesquioxane 106 was used to impregnate the mica papers 102. The impregnated mica papers 102 where subsequently dried of the isopropanol, and then thermoset cured.

In particular, the synthesis of the silsesquioxane 106 proceeded as follows: about 0.035 moles of total alkoxysilane was mixed with 0.039 moles of water and 0.012 moles of HF (as a 48% solution) . If desired, the HF and some of the phenyltriethoxysilane could be replaced with 0.022 moles of phenyltrifluorosilane. Then, the ratio of phenyl to methyl functionalized siloxane was adjusted to deliver a silsesquioxane material 106 with a target index of refraction according to the following equation: n=1.41+0.19* (mole % phenyl) (detailed formulations are listed in TABLE 3). The mixture of alkoxide, water and HF was shaken at 70° C. until it became homogeneous and clear and then it was allowed to age for 5 hours total at 70 to 80° C. This process initiated hydrolysis of the precursors, and resulted in a clear fluid solution or sol. A sample of the clear sol was then placed in an open beaker and allowed to dry overnight. This step in the process increased the degree of condensation, and left a colorless and clear-to-hazy syrupy product free of solvent. The resulting resin had a typical mass loss of between 30 and 50% upon drying. For spraying purposes, the resin was then re-dissolved in isopropanol so it had a known weight fraction, typically 50%. The resulting solution of silsesquioxane 106 was fluid and clear.

TABLE 3

| Component | #1 | #2 | #3 | #4 |
|---|---|---|---|---|
| PDMS | 0.22 | 0.22 | 0.18 | — |
| MTES | 3.31 | 3.31 | 4.16 | — |
| PTES | 4.07 | 3.36 | 0.972 | 8.14 |
| H2O | 0.7 | 0.7 | 0.63 | 0.9 |
| HF | 0.5 | — | — | 0.5 |
| PTFS | — | 0.365 | 0.365 | — |
| Index | 1.50 | 1.49 | 1.45 | 1.60 |

All quantities in grams.
PDMS = polydimethylsiloxane,
MTES = methyltriethoxysilane,
PTES = phenyltriethoxysilane,
PTFS = phenyltrifluorosilane,
HF-48% HF solution

### 2. RESULTS AND DISCUSSION

### 2A. Process Development

The process of impregnating the commercial mica paper 102 with silsesquioxane 106 involved two steps: (1) impregnating/filling the porous mica paper 102 with the sol silsesquioxane 106; and (2) curing the sol silsesquioxane 106 to form a dense flexible substrate 100. The goal was to avoid entrapment of air pockets while impregnating the mica papers 102, and to achieve a high quality surface texture. The various experiments were performed using 2″×2″ samples of mica paper 102.

### Impregnation of Mica Paper

To uniformly dose the mica paper 102 with sol silsesquioxane 106, a small nebulizer was used which produced a fine mist that was soaked onto both sides of the mica paper 102. To produce a well-metered spray, a mass flow system and syringe pump feeding the nebulizer was set-up to deliver ˜0.2 grams of sol silsesquioxane 106 over about 30 seconds. This allowed for the convenient processing of the 2″×2″ mica paper 102. The first nebulizer used in these experiments was a “Mira mist PEEK” nebulizer which was manufactured by Burgener Inc. Later, an Excentric quartz nebulizer manufactured by Texas Scientific Products was used because it was more robust than the “Mira mist PEEK” nebulizer. Various flow rates of nitrogen along with isopropyl alcohol were tested to create spray patterns on paper. It was determined that a 2 slpm flow provided an even/controlled spray.

The dosage of silsesquioxane resin 106 that was needed to impregnate the mica paper 102 was calculated from the ratio of the density of a well-impregnated mica paper 102 to a non-impregnated mica paper 102. It was found that about 30 to 35% by weight of silsesquioxane 106 would be needed to impregnate the pores 104 in both of the USSamica and Cogebi mica papers 102. If a sample mica paper 102 was processed with too little sol silsesquioxane 106, then the resulting flexible substrate 100 would show reduced transparency, flexibility, and toughness. Too much sol silsesquioxane 106, caused surface saturation or flash depending on the particular processing method. After the spray process the impregnated/filled mica paper 102 was then air dried, which left a tacky surface.

Alternatively, the mica paper 102 can be impregnated by a process in which a siloxane/alcohol solution is first pre-hydrolyzed prior to usage. After that, the following procedure can be used to saturate mica paper without damage:

1. Pre-flood an area on the glass substrate that approximated the planar area of a pre-cut mica paper film with a thin (˜150 um to 250 um) liquid film of the siloxane/alcohol solution.

2. Bring into a “floating contact” with the “pool” of siloxane/alcohol solution the mica paper sample, noting that settling occurs as the siloxane/alcohol solution enters and permeates the mica paper 102.

3. Allow an appropriate time (˜2 to 4 minutes) for the mica film 102 to fully uptake the siloxane/alcohol solution through capillary permeation at room temperature.

4. Pre-bake the film/substrate at 60 to 100° C. for 10 minutes to drive off the excess alcohol.

5. Transfer the pre-baked film/substrate to a higher temperature exhausted oven and then bake the sample at 150° C. for 20 to 30 minutes to drive the siloxane cure reaction to partial completion. The filled film/substrate at this point can be removed from the substrate due to a thin layer of partially-cured siloxane material which acts as a lubrication layer.

6. Cure the filled film/substrate (see next section).

Note 1: Continuous processing techniques to impregnate and cure the mica or inorganic paper 102 could be used. For instance, this may include a roll-to-roll process in which the mica or other inorganic paper 102 is first saturated with impregnating material 106 and then pressed followed by a heat treatment (if needed).

Note 2: Multiple impregnations of the impregnating material 106 or multiple impregnating materials 106 in the mica or inorganic paper 102 can be performed to insure total filling of the pores 104. Plus, intermediate drying between impregnations and then a final cure or multiple cures may be part of this process.

Note 3: Other ways of filling the pores 104 in the mica or inorganic paper 102 could be used. For instance, the mica paper 102 could be evacuated to remove gases and then, while still in the vacuum, it could be dipped in a solution of the impregnating material 106. Subsequent venting to atmospheric pressure would further force the impregnating material 106 into the pores 104.

### Cure Processing of Impregnated Mica Papers

Once the starting mica papers 102 were impregnated with the appropriate amount of sol silsesquioxane 106, a thermal processing step to cure the sol silsesquioxane 106 into an elastic form was performed. The key goal here was to fully cure the silsesquioxane matrix 106, while maximizing the density of the impregnated mica paper 102. Another, key goal was to produce an impregnated mica paper 102 which had a high quality surface. Three different cure methods are discussed herein and any one of them can be used to cure the impregnated mica paper 102. The cure methods include: (1) pressing an impregnated mica paper 102 between two hot plates; (2) supporting an impregnated mica paper 102 on a single flat plate in a vacuum; and (3) curing a suspended (hanging) impregnated mica paper 102 within a vacuum. These cure methods were all implemented with the same exemplary cure schedule in which the temperature was ramped to 140° C. for 10 to 30 minutes and then ramped to 250° C. and held for 10 to 60 minutes.

Pressed Tape Method

In this method, the resin saturated mica paper 102 was placed between two flat plates and pressed at pressures of between 500 and 2700 pounds. The application of pressure was useful in two ways, first, the compaction of the sol silsesquioxane 106 within the mica paper 102 could be controlled, and second, the surface quality could, at best, replicate the surface roughness of the plates. Both hard press surfaces and soft press surfaces were used in this method. The soft press surfaces such as PDMS (e.g., Sylgard 184) could be peeled away from the resin saturated mica paper 102. However, the soft press surfaces could tear, and sometimes did tear, the thinner consolidated mica paper 102b. In contrast, the hard press surfaces needed to have an intrinsically good release surface (e.g., non-stick aluminum foil) so the consolidated mica paper 102 could be removed from between the plates.

Alternatively, the impregnated mica paper 102 can be pressed by using a heated platen press (Carver) 200 as shown in FIG. 2A. The heated platen press 200 has a pair of presses 202a and 202b which are used to press therebetween the impregnated mica paper 102. In this example, each press 202a and 202b is made from a stacked kapton film 204a and 204b, aluminum foil 206a and 206b and an aluminum block 208a and 208 (shown separated from one another). The heated platen press 200 has been used to press samples of impregnated mica paper 102 while investigating various time, temperatures, and pressure combinations. For instance, two temperatures (200° C. and 235° C.) and times up to 420 seconds have been investigated while pressing samples of impregnated mica paper 102.

Supported Thin Tape Method

The process development around the two plate hot-pressing of the resin saturated mica paper 102 progressed while a parallel path of consolidation without pressure was also pursued. In this method, the curing process was modified so as to eliminate the pressure on the resin saturated mica paper 102 by placing it on a silicone pad and then curing it per the aforementioned thermal treatment schedule. This method effectively prevented the tearing of the resin saturated mica paper 102.

Hanging Thin Tape Method

In this method, a template was developed to suspend and support the mica paper 102 during the impregnating and curing steps. An exemplary template was manufactured by tracing an outline of the mica paper 102 onto a folded piece of heavy duty aluminum foil. Then, the traced area was removed, and the mica paper 102 was mounted inside the template with a piece of tape. The template was then sealed along the top and suspended from a ring stand with a binder clip. Thereafter, the mica tape 102 was sprayed with sol silsesquioxane 106 and cured in accordance with the aforementioned thermal treatment schedule. If desired, the heating could be done under vacuum within a vacuum oven to better promote the impregnated quality of the pores 104. This method produced the most transparent and uniformly impregnated mica papers 102, even though their edges often needed to be removed because the template covered small areas of the mica paper 102 and these areas were not treated. This particular method was relatively easy to perform and had excellent results.

### 2B. Results and Properties of Impregnated Mica Papers

### Visual and Microscopic Character

The thicker USSamica mica paper 102 produced an impregnated mica paper 100 that was easily wrapped around a tube with a radius of 5 cm, and was quite clear, but had optical scattering that distorted the view of an object through the paper 102. The thinner Cogebi mica paper 102 produced a more transparent and flexible product, which had sufficient flexibility to wrap around a 5 mm radius of curvature. In addition, the Cogebi mica paper 102 had significantly less distortion due to optical scattering when compared to USSamica mica paper 102. FIG. 2B shows a comparison of these two mica papers 102 before and after impregnating/filling them with silsesquioxane 106. The unimpregnated USSamica mica paper 102a and the impregnated USSamica mica paper 102a′ are shown on top of a book cover in the left photo. And, the unimpregnated Cogebi mica paper 102b and the impregnated Cogebi mica paper 102b′ are shown on top of the same book cover in the right photo.

### Cross Section Electron Microscopy

SEM micrographs of polished cross-sections of two impregnated mica papers 102 are shown in FIG. 2C (impregnated USSamica mica paper 102a′) and FIG. 2D (impregnated Cogebi mica paper 102b′). Generally, the SEM micrographs indicate that the impregnated mica papers 102a′ and 102b′ consist of laminar books of mica largely oriented in parallel sheets (shown in lightest contrast). They also indicate that the sol-gel silsesquioxane 106 occupied several types of pore structures, both large inter-laminar void spaces, as well as smaller inter-laminar spaces. As can be seen, the impregnated USSamica mica paper 102a′ appears to have a coarser structure, larger mica platelets and larger inter-laminar voids than the thinner Cogebi mica paper 102b′. Most importantly, the SEM micrographs indicate that the cure methods used to impregnate the pores 104 happened to be quite effective, and that the composite structure 102a′ and 102b′ was dense. In fact, voids which might have arisen from volatilization, offgassing or shrinkage did not appear in the SEM micrographs.

### Surface SEM

The surfaces of an unimpregnated USSamica mica paper 102a (left photo) and an impregnated USSamica mica paper 102a′ (right photo) are illustrated in 250× SEM micrographs of FIG. 2E. And, the surfaces of an unimpregnated Cogebi mica paper 102b (left photo) and an impregnated Cogebi mica paper 102b′ (right photo) are illustrated in 250× SEM micrographs of FIG. 2F. As can be seen, the surface of the unimpregnated USSamica mica paper 102a is characterized by overlapping plates of large mica books. In fact, crevices are visible that appear to be 10's of microns deep, while the impregnated USSamica mica paper 102a′ has a surface composition which is roughly equally to non-impregnated mica paper 102a and cured silsesquioxane 106. The silsesquioxane 106 appeared to impregnate much of the deepest voids in the mica paper 102a, but the surface was still heterogeneous, and a significant surface roughness was apparent. In contrast, the Cogebi mica paper 102b was less coarse to begin with which resulted in less extensive overlapped particles. The impregnated Cogebi mica paper 102b′ was a bit more subtle, and the silsesquioxane 106 could be seen gluing the particles together, as well as sitting in islands on the top surface of the mica paper 102b. The simple press and cure method used in this test was clearly more efficient at impregnating large spaces between mica flakes than it was at providing a finely planarized surface.

### Surface Quality-Interferometry

The surface texture of any display substrate 100 needs to be able to support the post-processing deposition of electronics on top of the surface. For instance, a silicon deposition process requires that an electronic component be deposited on a surface with <10 nm roughness. In this experiment, the surface roughness of the impregnated mica papers 102a′ and 102b′ was measured by WYCO interferometry. FIGS. 2G and 2H show surface maps of the USSamica mica paper 102a and 102a′ before and after the infiltration and the consolidation which was done by pressing them between two silicone plates. As can be seen, the surface texture was dominated by mica flakes with a peak-to-valley height of 15 microns before the impregnating and 8 microns after the impregnating. However, the silsesquioxane 106 reduced the higher frequency roughness which was indicated in the SEM photos of FIG. 2E. FIGS. 2I and 2J respectively compare the surface roughness of non-stick aluminum foil alone, and a impregnated USSamica mica paper 102a′ consolidated between two steel plates which used non-stick aluminum foil as a release. The surface texture of the impregnated USSamica mica paper 102a′ was nearly identical to that of the foil, indicating that the hard press surface can move the mica particles and resin into a conformational surface. In fact, the embossing was so complete that arrays of 15 micron stamped dots in the foil used to indicate the brand name were replicated in the surface of the impregnated USSamica mica paper 102a′. The roughness average in the impregnated USSamica mica paper 102a′ was ˜300 nm, or thirty times greater than is needed for a-Si deposition. This high fidelity embossing capability suggested that there is another way which can be used to satisfy the surface quality issue which is to use a smooth emboss method during consolidation. This smoothing process may include an additional silsesquioxane application step followed by a continuous roller, static press, or other embossing/smoothing method. Plus, additional planarization layers of silsesquioxane 106 may be applied to filled mica paper 102 to achieve the required surface roughness for a particular application.

### Mechanical Evaluation of Cure

Once, the samples of filled mica paper 102 were heated and cured under pressure, a non-destructive way to monitor the extent of the cure progression was desired to determine package breakdown. A method to measure the amount of cure a composite sample of impregnated mica paper 102 has undergone without destroying the sample has been demonstrated using a cantilever beam geometric configuration 210 like the one shown in FIG. 2K. As can be seen, the sample of impregnated mica paper 102 has one end attached to a support/wall 210 and another end attached to a weight 212. This test determines the_elastic deflection f_{B} which is a measure of the degree to which impregnated mica paper 102 will bend while under a load. The elastic deflection f_{B} is defined as follows:

f_{B}=(F*L³)/3*(1/(EI))

where F=force acting on the tip of the impregnated mica paper 102.

L=length of the impregnated mica paper 102.

E=modulus of elasticity.

I=area moment of inertia.

(E*I) is the stiffness of the impregnated mica paper 102.

As can be seen, the deflection of the impregnated mica paper 102 is inversely proportional to the stiffness of the impregnated mica paper 102. This relationship can be represented as follows:

f_{B} α 1/stiffness.

As the impregnated mica paper 102 cures, the stiffness increases, so the deflection is also inversely proportional to the degree of cure. This relationship can be represented as follows:

f_{B} α 1/“degree of cure.”

Then, by measuring the deflection for an applied mass loading, a curve of the f_{B} vs. cure time at various temperatures for four samples of impregnated mica paper 102 was constructed as shown in FIG. 2L. Samples in this study were 5 cm×5 cm, with a mass=6.452 g. Deflections were quite uniform with little or no torsion in the sample.

In this plot, it is noted that the two samples of impregnated mica paper 102 which were cured at 200° C. show slight increases in raw deflection at first, followed by a slight decrease in deflection at longer times. Thus, the total change in deflection (from initial to final time t) for these two samples cured at this lower temperature was approximately zero. However, from the other two samples of impregnated mica paper 102 which were cured at 235° C., a steady decline was seen in deflections with the added cure time. Here, the total change in deflection was substantial, 6 to 10 mm in extent after 200 to 400 seconds cure duration.

To make this analysis easier, a master curve of the % change in stiffness (% ΔEI) vs. time at both temperatures was constructed to be as follows (see also the graph shown in FIG. 2M):

% ΔEI=((EIₜ−EIₒ)/EIₒ)*100%=((fBₒ/fBₜ)−1)*100%

where EIₜ=change in stiffness at time t.
EIₒ=Initial stiffness at time 0.
fBₒ=Initial deflection at time 0.
fBₜ=Deflection at time t.

From the graph shown in FIG. 2M, it can be observed that for the lower cure temperature of 200° C., there is essentially no change (or very little change) for the cure time up to 420 seconds. On the other hand, for the higher cure temp of 235° C., it is evident that the stiffness of the sample impregnated mica paper 102 had increased with added cure time. A simple comparison of the slopes of these two curves shows that the rate of reaction (stiffness increase) at 235° C. was roughly 7× the rate of reaction at 200° C.

### Optical Absorption Spectroscopy

The impregnated mica paper 102a′ and 102b′ where evaluated for optical absorption over the spectral range of 300-1100 μm using a Hewlett Packard 8453 spectrometer. The Hewlett Packard 8453 spectrometer works by probing the electronic transitions of molecules as they absorb light in the UV and visible regions of the electromagnetic spectrum. This test was performed because with transmissive display components it is desirable to minimize any color imparted by a particular absorption peak within the visible range, as well as maximize the total transmission. However, some degree of optical scattering within a substrate may be beneficial for OLED light extraction purposes or other purposes. To perform this test, the impregnated USSamica mica paper 102a′ (80 microns thick) and impregnated Cogebi mica paper 102b′ (15 microns thick) were mounted in a sample holder ˜5 cm from the spectrometer. The silsesquioxane 106 which was used in this test had composition #1 as indicated in TABLE 3. The spectra are shown in FIG. 2N.

As can be seen, the spectra show an absorption tail from the UV into the blue, as well as small absorptions near 600 and 800 nm. More significant, is the fact that the overall attenuation was quite high, with transmission below 15% for the thinner Cogebi mica paper 102b′, and below 3% for the USSamica mica paper 102a′. And, when normalized for thickness, the attenuation was nearly equal between the two samples of impregnated mica paper 102a′ and 102b′. FIG. 2O shows the impact of light scattering off of the textured samples 102a′ and 102b′ which was measured by repeating the absorption experiments on the impregnated Cogebi mica paper 102b′ using a Hitachi UV/VIS spectrometer equipped with an integrating sphere detector. In this test, the top measurement in the plot was obtained with an integrating sphere detector and the bottom measurement in the plot was obtained with a standard transmittance detector setup. This test was designed to capture the light scattered behind the impregnated Cogebi mica paper 102b′, so the attenuation would be due to absorption, forward scattering and reflection losses. As can be seen in FIG. 2O, the strong absorbance from the UV tail impacted the transmission in the blue, but the total transmission was still near 80%. The scattering was believed to arise from multiple index of refraction differentials within the light path. Unfortunately, the sample composite mica paper 102b′ was not perfectly tuned so that the silsesquioxane 106 and mica paper 102 had the same index and as a result there were many reflective interfaces, which accounted for most of the light scattering.

### Thermal Expansion

FIG. 2P is a graph that shows the expansion behavior of impregnated USSamica mica paper 102a′, as measured by a Dynamic Mechanical analyzer. In this test; a 2×2 cm piece of impregnated USSamica mica paper 102a′ was measured for dimensional change over a temperature range of 20° C. to 300° C. A linear response in both the heating curve 214 and the cooling curve 216 was observed and no hysteresis was observed. This indicated that the impregnated USSamica mica paper 102a′ did not compact during the measurement, which indicates dimensional stability. From the slope of the curves 202 and 204, a value for the expansion coefficient was calculated to be 7 ppm/° C.

The CTE of this particular impregnated USSamica mica paper 102a′ was dominated by the expansion of the inorganic silsesquioxane 106, so that the expansion penalty relative to a silicon layer was a modest 3 ppm/° C. (silicon has an expansion of ˜4 ppm/° C.). In contrast, most polymer substrates are characterized by a high expansion that is in the 20 ppm/° C. range. Thus, projecting the stress derived for an amorphous silicon product which is deposited at 200° C. on a traditional polymer substrate, versus a 300° C. deposition process on the impregnated USSamica mica paper 102a′, indicates 3.5 times more stress in the polymer substrate (as estimated by neglecting modulus differences and calculating proportional ΔCTE*ΔT values for the polymer film and the impregnated mica paper 102a′ respectively: [200−40]*180 for the polymer substrate, [70−40]*280 for the impregnated mica paper 102a′).

### Helium Permeation

Helium permeation was measured by placing sheets of composite/impregnated mica papers 102a′ and 102b′ into a fixture and pressurizing one side with He and evacuating the other side. The helium that passed though the sample composite mica papers 102a′ and 102b′ was then measured with a residual gas analyzer. Prior to this measurement, the sample composite mica papers 102a′ and 102b′ were evacuated for approximately 14 hours to help assure a complete purging of the system. The comparative permeation behavior was estimated by measuring the time before the helium breakthrough. In effect, this was a surrogate measurement for oxygen and water permeation, the thought being that a helium measurement allows a faster evaluation due to its much higher diffusivity.

FIG. 2Q shows the helium flux measured for several types of materials of interest which could be used in a flexible display. The traditional Topaz polymer substrate is a high temperature polymer that was found to provide a rather low diffusivity when compared to other polymeric systems. The Helium flux measurements for a total of four samples of USSamica mica paper 102a′ and Cogebi mica paper 102b′ were plotted, along with a measurement made using a traditional Corning 0211 Microsheet glass substrate with a thickness of 75 microns. In this type of diffusivity measurement, it should be appreciated that the flux is proportional to the diffusivity, and is reciprocal to thickness. Of the samples measured, the two Cogebi mica papers 102b′ where by far the thinnest @15 microns, while the other samples ranged in thickness from 80 microns (the USSamica mica papers 102a′), up to 500 microns (the Topaz polymer substrate). Two aspects of this measurement are of particular importance, the rate at which the helium diffuses through the thin sample (as indicted by the initial slope of the helium signal per time) and the steady state flux. For similar samples, these values correlated to one another, but for dissimilar samples each of these values needed to be qualitatively examined. The results showed that the impregnated mica papers 102a′ and 102b′ occupied a middle ground between the low diffusivity Microsheet glass substrate and the rather permeable polymer substrate. In one case, the sample USSamica mica paper 102a′ (composite A) showed very low helium flux, which closely approximated the Microsheet glass substrate. In the other case, the USSamica mica paper 102a′ (composite B) and the two Cogebi mica papers 102b′ each had a helium flux that was more substantial, although it was not more than 1/10^{th} of the Topaz polymer's flux, in spite of the sample mica papers 102a′ and 102b′ being 6 to 33 times thinner than the Topaz polymer substrate.

FIG. 2R is a plot of relative He permeation of several impregnated mica papers 102a′ and 102b′ as a function of time. As can be seen, the performance of the pressed mica papers 102a′ and 102b′ (which were 5× thinner) was similar to the high permeability USSamica mica paper 102b′ (composite B shown in FIG. 2Q). Plus, it can be seen that the aging of one of the Cogebi impregnated mica papers 102b′ for 10 hours at 300° C., increased the flux by a factor of about 6. Note: if one were to replace a lower index silsesquioxane 106 used in this test with a higher index silsesquioxane 106 then it is believed the flux could be reduced further by a factor of 2.

The behavior of the tested composite impregnated mica papers 102a′ and 102b′ seen during the qualitative evaluation of the permeation test indicated that they had a substantially lower permeation rate than the Topaz polymer substrate (which was found to be an order of magnitude better than a polypropylene substrate). But, the ultimate performance appeared to depend on the particular processing of the composite impregnated mica papers 102a′ and 102b′. For instance, the permeation was sensitive to defects, and it was believed that much of the variation observed in the tested mica papers 102a′ and 102b′ was due to poorly optimized processing. Indeed further experimentation has shown that the He permeation rate in impregnated mica papers 102 may be impacted by the surface roughness of the substrate, which can allow permeation around the sample impregnated mica paper 102 through gaps between the substrate and the Viton gaskets in the test apparatus. Several replications have been demonstrated of the performance obtained for USSamica mica paper 102a40 composite A with similar composite substrates. Although the permeation rate of the various silsesquioxanes 106 is not known (because they are highly networked structures when compared to silicones and polymers), it was not surprising to find that they had a significantly better permeation resistance.

### Thermal Durability by Thermo Gravimetric Analysis

In this test, a thermo-gravimetric analysis was performed on partially cured Cogebi impregnated mica papers 102b′. Several samples of Cogebi mica papers 102b were spray impregnated with silsesquioxane 106 and then pre-cured to 130° C. for 1 hour before testing. FIG. 2S is a graph that shows the thermo-gravimetric results over a temperature range of 20 to 1000° C. where the mass loss events were centered at 260° C., 537° C. and >600° C. As can be seen, the partially cured mica papers 102b′ showed a 10% weight loss over the entire run. Since, the silsesquioxane 106 makes up about 30% of the total sample's weight, this correlated to about 30% mass loss in the impregnating material 106 based on the assumption that all of the lost weight was from the burning-off of the organic groups. The differential trace in the graph indicated that the mass loss events occurred in three areas:

1. About 2% loss between 200 to 300° C. corresponding to elimination of water as the sample was completely cured. The sample was expected to be thermally stable at these temperatures because of the initial elimination of water.

2. About 6 to 7% loss between 400 and 700° C. due to the decomposition of methyl and phenyl groups from the matrix phase of silsesquioxane 106.

3. About 0.5 to 1% loss above 700° C. could have corresponded to the continued oxidation of the silsesquioxane 106, or the dehydration of the mica paper 102.

These results underscored the notion that the composite impregnated mica paper 102a′ and 102b′ should be processed near 250° C. to fully condense the network, and that they potentially could be processed at temperatures near 400° C.

### Thermal SEM Durability by Thermal Aging

Thermal durability tests where performed on samples of impregnated USSamica mica paper 102a′ and impregnated Cogebi mica paper 102b′ by first curing them at 130° C. for 16 minutes and then 180° C. for 10 minutes. The pre-cured impregnated mica papers 102a′ and 102b′ were then aged in a box furnace for various times at different temperatures. The mass of the impregnated mica papers 102a′ and 102b′ where monitored before and after the heat treatment. In addition, the discolorations or textural changes, if any, were monitored before and after the heat treatment. The results of this test are presented in TABLES 4 and 5.

TABLE 4
(USSamica mica paper 102a′)*

| | Initial | final | % | |
|---|---|---|---|---|
| Test | weight | weight | loss/gain | Comments |
| 85/85 24 | .2317 | .2316 | −.04% | No color change. No |
| hours | | | | blistering. Stiffer texture, |
| | | | | unchanged brittleness as |
| | | | | untreated sample. |
| 85/85 1 | .2198 | .2182 | −0.7% | No color change. No |
| week | | | | blistering. Texture stiffer |
| | | | | than 85/85 24 hr. |
| | | | | No change in brittleness. |
| 200° C. 10 | .2522 | .2499 | −0.9% | No color change. No |
| hours | | | | blistering. Texture is |
| | | | | stiffer. Slightly less |
| | | | | brittleness. |
| 250° C. 10 | .2101 | .2085 | −0.8% | No color change. Small |
| hours | | | | blister in center. Texture |
| | | | | slightly stiffer than |
| | | | | 200/10 hr. Same |
| | | | | brittleness as 200/10 hr. |
| 300° C. 1 | .2484 | .2450 | −1.4% | No color change. Several |
| hour | | | | small blisters on ½ |
| | | | | sample. Same stiffness as |
| | | | | 200/10 hr. Slightly more |
| | | | | brittle than 250/10 hr. |
| 300° C. 10 | .2500 | .2467 | −1.3% | No color change. Several |
| hours | | | | small/medium blisters on |
| | | | | ½ sample. Stiffer and |
| | | | | less brittle than 300/1 hr. |
| RT H₂O soak | .2067 | .2075 | +0.4% | Same as untreated |
| 24 hours | | | | sample. |
| 100° H₂O | .2581 | .2602 | +0.8% | No color change. Soft |
| soak 4 | | | | texture. Least flexible- |
| hours | | | | most difficult to bend |
| | | | | without cracking. After |
| | | | | heating to 60° x2 hours, |
| | | | | sample weighed .2582 g. |

*The particular silsesquioxane 106 used had composition #1 in TABLE 3.

TABLE 5
(Cogebi mica paper 102b′)*

| | initial | final | % | |
|---|---|---|---|---|
| test | weight | weight | loss/gain | Comments |
| 85/85 24 | 0.0832 | 0.0827 | −0.6% | No change in transparency, |
| hours | | | | texture, or brittleness than |
| | | | | uncharacterized sample. |
| 85/85 1 | .0799 | .0795 | −0.5% | No change in transparency. |
| week | | | | More stiff and brittle than |
| | | | | uncharacterized sample. |
| 200° 10 | .0781 | .0768 | −1.7% | No change in transparency. |
| hours | | | | Slightly more stiff and |
| | | | | brittle. |
| 250° 10 | .0917 | .0895 | −2.5% | No change in transparency, |
| hours | | | | stiffer and more brittle. |
| 300° | .0812 | .0798 | −1.7% | No change in transparency, |
| 1 hour | | | | stiffer texture, no change in |
| | | | | brittleness. |
| 300° 10 | .0946 | .0923 | −2.4% | No change in transparency. |
| hours | | | | Stiffer |
| | | | | texture, increase in |
| | | | | brittleness. |
| 350° 10 | .0868 | .0839 | −3.3% | No change in transparency. |
| hours | | | | Increasingly stiffer texture. |
| | | | | Brittleness equal to 300°/10 |
| | | | | hours. |
| 400° 10 | .0848 | .0811 | −4.4% | No change in transparency. |
| hours | | | | Stiffer than 400°/10 hours. |
| | | | | Brittleness equal to 300°/10 |
| | | | | hours. |
| 450° 10 | .0860 | .0803 | −6.6% | No change in transparency. |
| hours | | | | Much stiffer. Brittleness |
| | | | | equal to 300°/10 hours. |
| 500° 10 | .0845 | .0811 | −4.0% | Slightly darker, more |
| hours | | | | reflective than untreated |
| | | | | sample. As stiff and brittle |
| | | | | as 450°/10 hours. |
| 550° 10 | .0905 | .0844 | −6.8% | Much darker, mottled |
| hours | | | | appearance. Can still read |
| | | | | text well. Very stiff and |
| | | | | brittle. Cracked under stress |
| | | | | others could take. |
| 800° 10 | .0802 | .0725 | −9.6% | Gray-black, paper curled up, |
| hours | | | | difficult to read text. Very |
| | | | | stiff and brittle, though will |
| | | | | still bend with ease. |
| RT H₂O | 0.0851 | 0.0867 | +1.9% | No change in transparency, |
| soak | | | | texture, or brittleness. |
| 24 hours | | | | |
| 100° H₂O | .0806 | .0824 | +2.2% | No change in transparency. |
| soak 4 | | | | Slightly softer texture, more |
| hours | | | | brittle than RT sample. |

*The particular silsesquioxane 106 used had composition #1 in TABLE 3.

Considering that the samples of the impregnated mica papers 102a′ and 102b′ had not been fully cured, the behavior under milder conditions-water soak, 85/85, and exposures at up to 300° C. for up to 10 hours was quite good.

### Chemical Durability

A chemical durability test was performed on both types of impregnated mica papers 102a′ and 102b′ by first curing them at 150° C. for 45 minutes and 180° C. for 30 minutes, and then subjecting the cured impregnated mica papers 102a′ and 102b′ to a series of chemical exposures. The different exposures had been chosen to simulate the different types of processing environments that one might experience in a semiconductor application.

Chemical Resistance Studies

Several samples of thin Cogebi impregnated mica paper 102b′ (in which the silsesquioxane 106 used had composition #1 in TABLE 3) were exposed to a matrix of chemical treatments for one hour. The samples were then dried in a 60° C. oven for one hour, reweighed, and observed for changes in appearance and texture. In addition, there where two samples of thin Cogebi impregnated mica paper 102b′ which were not processed in this way but instead they were treated with acetone and isopropyl alcohol and allowed to air dry for one hour before re-weighing. The results of this test are shown in TABLE 6:

TABLE 6

| Chemical | | | |
|---|---|---|---|
| treatment | Mass change | Appearance | Texture |
| ITO etch | −1.64% | No change | No change |
| Al Etch | +7.38% | No change | More flexible, |
| | | | softer |
| 1 M KOH | −10.95% | Slightly darker | Feels thicker |
| Acetone | −5.49% | No change | No change |
| IPA | −0.68% | No change | No change |
| Photoresist | −18.85% | Darker, more | Rougher, drier. |
| stripper | | opaque, | Less flexible. |
| | | discolored | |
| Photoresist | −6.29% | Slightly darker | Rougher, feels |
| developer | | | thicker |

Notes:
ITO = v/v of 18.5% HCl; 4.5% HNO₃; 77% H₂O
Al = v/v of 64% H₃PO4; 8% HNO₃; 10% CH₃COOH
Photoresist stripper = Shipley Microposit Remover 1165
Photoresist developer = Shipley Microposit 351 Developer

As can be seen, durability in the base exposures caused mass loss and degradation of the sampled Cogebi mica paper 102b′. This was likely due to poor durability of the primary mica phase in the thin Cogebi mica paper 102b. In contrast, the acid and organic exposures where less severe, although the strong phosphate acids did cause some softening of the matrix.

Other porous forms may be used as starting materials for silsesquioxane based composites. The following example illustrates that the aforementioned process for forming a flexible material 100 can broadly encompass porous inorganic forms, both in inorganic composition and in amount and form of the porosity. For instance, a flexible tape 100 was prepared by impregnating silsesquioxane 106 into commercially available Nippon Sheet Glass paper (TGP-010). This experiment was conducted to demonstrate a generality in the processing capability from a rather dense mica paper 102 (discussed above) to a very porous glass fiber paper 102 (discussed next). The experiment also demonstrated how the properties of the filled porous glass fiber paper 100 are impacted by parameters such as inorganic fill, and form. In this experiment, the TGP010 paper 102 used was extruded chopped fiber which had a porosity of >90%. A sample of the paper 102 was cut and weighed to set up a target impregnation volume of the silsesquioxane resin 106. The target weight of the final cured composite 100 was 8.2 times the mat weight of the original fiber paper 102 which indicated how much silsesquioxane resin 106 was needed to fill the pores 104 within paper 102.

Next, the required amount of silsesquioxane resin 106 was prepared as formulation 2 from Table 3. The silsesquioxane resin 106 was dried overnight, and weighed. Then, the silsesquioxane resin 106 was diluted to 0.914 times the as-prepared mass of the formulation. The paper 102 was dosed with 19.4 g of the diluted silsesquioxane resin per gram of the fiber mat to provide the proper resin to glass fiber ratio. Because of the extreme fragility of the paper, the sol 106 was soaked into the paper 102, while the paper 102 was supported on a setter. Two dosing procedures were needed, each using about half of the prescribed volume of diluted resin 106, followed by drying at room temperature for 12 hours. The filled paper 102 was then pre-cured in a vacuum oven at 200° C. for 10 minutes which left a tacky flexible tape.

For final curing and surface forming, a hot pressing method was used in which the filled tape 102 was placed between two layers in a release package where each of the layers included one layer of aluminum foil tape and one layer of polyimide film. The assembled package was then placed between parallel hot platens in a Carver hydraulic press and allowed to equilibrate at 250° C. for 1 to 2 minutes. Then, about 100 to 1000 pounds or typically about 100 to 200 psi was applied to the platens and the package was held under pressure at 250° C. for 30 minutes. The pressure was then released and the release package was cooled. The glass fiber filled resin 100 (which was a colorless slightly translucent tape 100) was peeled from the Al foil and Kapton film. With this package, the Al foil surface was relatively smooth, and the Kapton surface helped prevent roughness during the press process. Alternate hot press package options include: (1) using two Kapton layers which retain more of the residual paper texture on both surfaces, or (2) using two layers of foil, which can lead to regions of the tape 102 that do not receive the full pressure, and therefore do not fully conform to the smooth surface, due to local thickness variations in the Al foil.

FIG. 2T illustrates a SEM of the resulting filled tape 100 in cross-section which shows the well dispersed low glass fiber fraction. The glass fibers show up as white features in the darker matrix of silsesquioxane 106. The composite tape 100 was flexible, and able to withstand multiple bends over 7 mm cylinder. The optical absorption test showed a spectrally neutral color, with scattering loss arising from an index of refraction mismatch of the silsesquioxane 106 with the glass fiber 102. The CTE was measured to be between 25 and 30 ppm/° C., reflecting the expansion of the silsesquioxane 106, with little composite effect from the chopped fiber.

In an alternative embodiment, a carbon nanotube paper 102 was used to demonstrate another form of flexible filled composite 100. In this experiment, a silsesquioxane 106 composition was prepared as formulation 2 from Table 3. After drying overnight, the silsesquioxane resin 106 was heated to 140° C. for 10 minutes, along with the carbon paper. The carbon nanotube paper disc 102 was then floated on the sol 106 for 5 minutes under vacuum, and then after venting the system the paper 102 was turned over and the vacuum treatment was repeated. After venting the system the paper 102 was held vertically in the vacuum oven while it was heated to 250° C. for one hour under vacuum to complete the curing of the silsesquioxane 106. During the ramp-up in temperature some silsesquioxane resin 106 drained off of the carbon paper 102. After curing, the resulting black tape 100 was leathery and flexible (note the paper 102 originally weighed 0.035 g now weighed 0.498 g after this process).

In another embodiment, a potassium silicate was used as an impregnating material 106 to fill mica paper 102. In one test, USSamica mica paper 102 was impregnated with a 29% solids solution in water of a potassium silicate with SiO₂/K₂O weight ratio of 2.5 (note: PQ Corporation provides a variety of potassium silicates in their Kasil® product line). The solution was applied to the surface of the sample USSamica mica paper 102a′ and allowed to soak in. The sample USSamica mica paper 102a′ was then air dried at room temperature overnight and then dried in an oven at 150° C. For bonding the mica paper 102 to a formed glass surface, the potassium silicate solution 106 was applied as a thin film to the glass via brushing followed by sticking the mica paper 102 to the glass on the side to which the potassium silicate solution 106 was applied. Then, the sample USSamica mica paper 102a′ was dryed and cured. This serves as an example of another method and material system capable of impregnating an inorganic material that contains interstices or voids. The processing steps required to fabricate this type of composite are at temperatures <1000° C. and provide a composite capable of surviving temperatures >300° C. and having a bend radii <5 cm. If desired, several additional steps can be performed to chemically set, alter the impregnating material's mechanical, alter the chemical durability, or alter it's local composition.

Another example of commercially available impregnating material is sold under the brand name of HardSil™ AP from Gelest. This impregnating material is a curable polysilsesquioxane T-resin with a thermal capability of up to 360° C.

### CONCLUSIONS

Trends in display technology indicate that cost reduction and new form factors are going to become increasingly important in the future. For instance, reel-to-reel processing of displays is seen as a significant cost reduction method, where rolls of flexible substrate 102 can be passed through a series of processing stations in a continuous sequence, thereby improving manufacturing efficiency. The ability of the flexible substrate 102 to withstand bending around 30 cm diameter rollers with tensile stress applied constitutes an additional requirement to all of the other material properties desired for a final article performance. Plus, the ability to easily cut the final display to size, while maintaining reasonable toughness is important. In addition, new forms of flexible displays are envisioned which may store the display in a scroll form, where the inactive state of the display is a roll of <2 cm diameter. Again, this extreme flexibility is an additive requirement to the other properties which are needed for the functionality of image processing (see TABLE 1). To support these future technologies an increasing array of display technologies is also being developed, including OLED, electrophoretic, cholesteric liquid crystal, and silicon technologies, in transmissive and reflective system designs, and utilizing passive and active matrix electronics. As a result, it is believed that some combination of the following properties will be important to have in flexible substrates 100: (1) flexibility to allow repeated bending to <30, <5, <1, or <0.5 cm radius; (2) thermal durability to allow a-Si processing or other electronic >300° C., >350° C., or >400° C.; (3) transparency; (4) low permeability to gases and water; (5) low expansion <20, <10, or <7 ppm/° C.; (6) chemical durability to semiconductor processing fluids; (7) stability in difficult use conditions such as 850° C./85% RH; (8) surface roughness (Ra) values <0.5, <0.3 m or <0.1 microns; (9) composite fabrication temperatures <1000° C., <600° C., or <300° C.; (10) density >1.3 g/cm³, >1.6 g/cm³, >2 g/cm³; (11) tensile strength >200 MPa; (12) oxygen transmission rate <1 cc/m2/day, <0.05 cc/m2/day, <0.001 cc/m2/day (maximum); and (12) water vapor transition rate <1 g/m2/day, <0.05 g/m2/day, <0.001 g/m2/day (maximum). As can be seen, the exemplary flexible substrates 100 described herein did have some compelling desirable properties:

CTE=7 ppm/° C., a much better match to Si than polymer substrates.

He Permeability lower than polymer substrates (by a 2-3 orders of magnitude) but much higher than Corning Microsheet glass substrates.

Bend radius capability of about 5 cm for the thicker USSamica mica paper 102a′, and 5 mm for the thinner Cogebi mica paper 102b′.

Thermal stability to 350° C., without mass loss or compaction.

No noticeable effect from aging at 850° C./85% RH over a one week period.

Good chemical durability in solvents.

Composite fabrication temperatures <500° C.

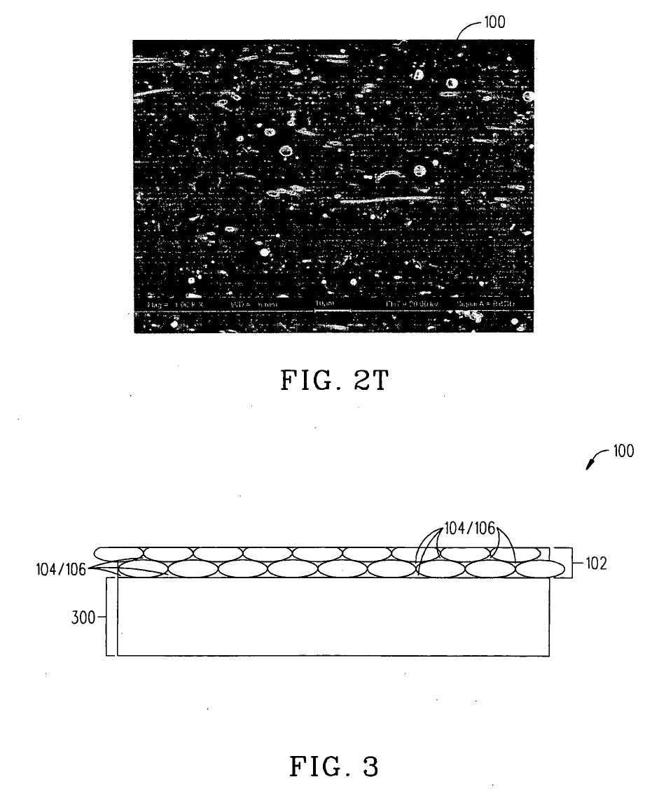

FIG. 3 is a cross-sectional side-view of the flexible substrate 100 (impregnated inorganic material 100) being used as a protective coating on a glass substrate 300 in accordance with another embodiment of the present invention. For instance, the glass substrate 300 could be 50-100 microns thick and have an electronic device (e.g., OLED, semiconductor, RFID) formed on the non-protected surface. In this application, the glass substrate 300 would provide the overall barrier performance, and the flexible substrate 100 would provide the scratch resistance. In particular, the inorganic particles in the flexible substrate 100 could inhibit a defect from propagating to the surface of the glass substrate 300. And, the inorganic particles in the flexible substrate 100 could protect the glass substrate 300 by distributing the force of a puncturing object.

To demonstrate this concept, two un-impregnated mica papers 102 were adhered to Eagle® glass substrates (manufactured by Corning Inc.) by respectively using two different materials—potassium silicate glass 106 (e.g., potassium silicate glass with weight ratio of SiO₂/K₂O of 2.5) and sol-gel silsesquioxane 106. In both cases, the respective bonding agent 106 impregnated the mica paper 102, and then the mica particles bonded to the surface of the glass substrate 300 after the curing step.

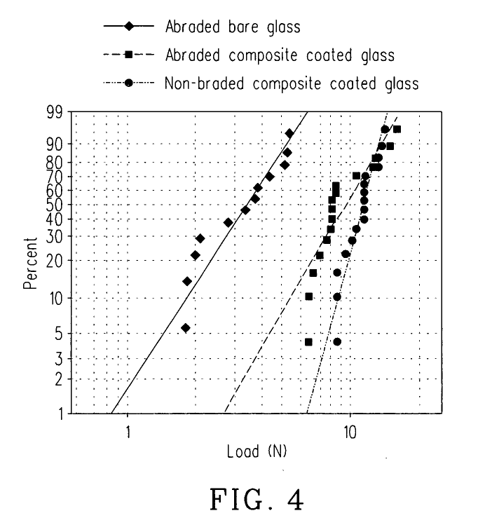

In another test, an unimpregnated commercially available mica paper 102 was laminated to a 75 um Corning 0211 Microsheet glass substrate 300 using potassium silicate glass 106. Then, ring-on-ring strength measurements where performed on a mica paper laminated microsheet glass substrate 100/300. In addition, two other sample sets of the same configuration 300 and 100/300 where abraded with sandpaper. Abrasion occurred on the sample side that had the laminated mica paper if present. All three sample sets 300 and 100/300 where then strength tested with the abraded side (if present) in tension. FIG. 4 is a plot which compares the average load (force) required to break each of these sample sets 300 and 100/300. Testing of the abraded and non-abraded laminated samples 100/300 resulted in similar failure loads. However, testing of the bare abraded glass 300 resulted in a much lower failure load.

Following are some advantages, features and uses of the present invention:

1. The flexible substrate 100 offers improved CTE, thermal capability, O₂ and water barrier properties, mechanical stability over traditional polymer substrates that are being used today. All of these properties offer advantages in both the final application as well as the manufacturing process. Plus, the fact that the substrate materials in these designs have lower O₂ and water permeation values when compared to other polymer substrates potentially allows the use of a lower performance/lower cost barrier layer 108.

2. The flexible substrate 100 has an increased dimensional stability which effectively improves the substrate's durability, lifetime, resistance to barrier layer micro-cracking, and manufacturability (via photolithography).

3. Laminating the flexible substrate 100 to a thin glass substrate 300 improves the durability and scratch resistance when compared to un-protected thin glass substrates.

4. The flexible substrate 100 has improved mechanical durability and is particularly resistant to breakage due to propagation of any surface and edge defects possibly present. One result of this is potentially low cost cutting methods to be used without a substantial decrease in mechanical durability or achievable bend radius.

Although two embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

1. An impregnated inorganic material, comprising:
a freestanding inorganic material with interstices impregnated with an impregnating material, wherein said impregnated freestanding inorganic material/impregnating material upon being cured/fabricated at <1000° C. has a temperature capability which is greater than 300° C.

2. The impregnated inorganic material of claim 1, wherein said freestanding inorganic material is selected from:
a mica paper;
a graphite paper;
a carbon nanotube paper; and
a glass fiber paper.

3. The impregnated inorganic material of claim 1, wherein said impregnating material is silsesquioxane.

4. The impregnated inorganic material of claim 3, wherein said silsesquioxane is RSiO_{3/2} where R is an organic modifier.

5. The impregnated inorganic material of claim 1, wherein said impregnating material is an alkali silicate glass which has a weight ratio of SiO₂/X₂O (where X is an alkali) between 1.6-3.5.

6. The impregnated inorganic material of claim 1, wherein said impregnated freestanding inorganic material/impregnating material, upon being cured/fabricated has one or more of these properties:
a thickness of 500 μm (maximum);
a CTE of 20 ppm/° C. (maximum);
an achievable bend radius of 5 cm (maximum); and/or
a surface roughness of 0.5 um (maximum).

7. The impregnated inorganic material of claim 6, wherein said impregnated freestanding inorganic material/impregnating material upon being cured/fabricated has one or more of these properties:
a density of >1.3 g/cm³ (minimum); and/or
a tensile strength of 200 Ma (minimum).

8. The impregnated inorganic material of claim 6, wherein said impregnated freestanding inorganic material/impregnating material upon being cured/fabricated has one or more of these properties:
an oxygen transmission rate of <1 cc/m²/day (maximum); and/or
a water vapor transmission rate of <1 g/m²/day (maximum).

9. A method for manufacturing a impregnated inorganic material, said method comprising the steps of:
providing a freestanding inorganic material;
providing a impregnating material;
impregnating a plurality of pores within said freestanding inorganic material with said impregnating material; and
curing said impregnated freestanding inorganic material to form said impregnated inorganic material, wherein a maximum temperature during the impregnating and curing steps is <1000° C., and wherein the cured impregnated inorganic material has a thermal capability of >300° C.

10. The method of claim 9, wherein said impregnating step further includes spraying said impregnating material onto said freestanding inorganic material.

11. The method of claim 9, wherein said curing step further includes pressing said impregnated freestanding inorganic material between two hot plates, rollers, or a combination of plates and rollers.

12. The method of claim 9, wherein said curing step further includes placing said impregnated freestanding inorganic material onto a single hot plate or roller.

13. The method of claim 9, wherein said curing step further includes:
suspending said impregnated freestanding inorganic material; and
heating said suspended impregnated freestanding inorganic material.

14. The method of claim 9, wherein said freestanding inorganic material is selected from:
a mica paper;
a graphite paper;
a carbon nanotube paper; and
a glass fiber paper.

15. The method of claim 9, wherein said impregnating material is silsesquioxane which has a general formula of RSiO_{3/2} where R is an organic modifier.

16. The method of claim 9, wherein said impregnating material is an alkali silicate glass which has a weight ratio of SiO₂/X₂O (where X is an alkali) between 1.6-3.5.

17. The method of claim 9, wherein said impregnated inorganic material which has been cured has one or more of these properties:
a thickness of 500 μm (maximum);
a CTE of 20 ppm/° C. (maximum);
an achievable bend radius of 5 cm (maximum); and/or
a surface roughness of 0.5 um (maximum)

18. The method of claim 17, wherein said impregnated inorganic material which has been cured has one or more of these properties:
a density of >1.3 g/cm³ (minimum); and/or
a tensile strength of 200 MPa (minimum).

19. The method of claim 17, wherein said impregnated inorganic material which has been cured has one or more of these properties:
an oxygen transmission rate of <1 cc/m²/day (maximum); and/or
a water vapor transmission rate of <1 g/m²/day (maximum).

20. The method of claim 9, wherein said impregnated inorganic material is used to make a flexible display.

21. The method of claim 9, wherein said impregnated inorganic material is used to make a flexible electronic.

22. A flexible substrate comprising:
a freestanding inorganic material with interstices impregnated with an impregnating material, wherein said impregnated freestanding inorganic material upon being cured has these properties:
a thickness of 500 μm (maximum);
a CTE of 20 ppm/° C. (maximum);
an achievable bend radius of 5 cm (maximum); and
a surface roughness of 0.5 um (maximum)

23. The flexible substrate of claim 22, wherein said impregnated freestanding inorganic material upon being cured has these properties:
a density of >1.3 g/cm³ (minimum); and/or
a tensile strength of 200 MPa (minimum).

24. The flexible substrate of claim 22, wherein said impregnated freestanding inorganic material upon being cured has these properties:
an oxygen transmission rate of <1 cc/m²/day (maximum); and/or
a water vapor transmission rate of <1 g/m²/day (maximum).

25. The flexible substrate of claim 22, further comprising a barrier coating/laminate placed on a surface of said impregnated freestanding inorganic material.

26. The flexible substrate of claim 22, wherein said freestanding inorganic material is selected from:
a mica paper;
a graphite paper;
a carbon nanotube paper; and
a glass fiber paper.

27. The flexible substrate of claim 22, wherein said impregnating material is silsesquioxane which has a general formula of RSiO_{3/2} where R is an organic modifier.

28. The flexible substrate of claim 22, wherein said impregnating material is an alkali silicate glass which has a weight ratio of SiO₂/X₂O (where X is an alkali) between 1.6-3.5.
